(19) United States
(12) Patent Application Publication
(10) Pub. No.: US 2026/0249861 A1
(43) Pub. Date: Aug. 27, 2026

(54) SYSTEM AND METHOD FOR RECOGNIZING OBJECT AND EVALUATING CONFIDENCE LEVEL BASED ON ARTIFICIAL INTELLIGENCE AND AUTONOMOUS DRIVING SENSOR

(71) Applicants: HYUNDAI MOTOR COMPANY, Seoul (KR); Kia Corporation, Seoul (KR)

(72) Inventor: Ji Yang MOON, Hwaseong-si (KR)

(21) Appl. No.: 19/415,554

(22) Filed: Dec. 10, 2025

(30) Foreign Application Priority Data
Feb. 27, 2025 (KR) 10-2025-0026234

(51) Int. Cl. B60W 50/00; B60W 60/00

(52) U.S. Cl. CPC B60W 50/0097; B60W 60/001; B60W 2050/0022; B60W 2554/4041

(57) ABSTRACT

A system and a method for recognizing objects using artificial intelligence (AI)-based processing and an autonomous driving sensor. The system recognizes an object present in a surrounding environment based on data input from the autonomous driving sensor, clusters a plurality of points corresponding to the object in the surrounding environment obtained from the autonomous driving sensor, generates a tracks for predicted objects, and assigns a confidence score to each of the predicted objects, where the confidence score is differentially assigned to each of the predicted objects based on a Region of Interest (ROI) of a vehicle during autonomous driving.

### CROSS-REFERENCE TO RELATED APPLICATION

Pursuant to 35 U.S.C. § 119 (a), this application claims the benefit of an earlier filing date and right of priority to Korean Patent Application No. 10-2025-0026234, filed in the Korean Intellectual Property Office on Feb. 27, 2025, the entire contents of which are incorporated herein by reference.

### TECHNICAL FIELD

The present disclosure relates to object recognition using Artificial Intelligence (AI) and an autonomous driving sensor.

### BACKGROUND

With the recent development and commercialization of autonomous vehicles, there has been a growing number of cases where various sensors and AI (Artificial Intelligence) technologies are used to support autonomous driving functions. For example, ongoing research focuses on recognizing whether any object exists in front of a moving vehicle, estimating the distance between the object and the vehicle, and determining how the vehicle should respond under specific scenarios based on appropriate algorithms to ensure safety.

As a result, vehicle sensor technologies have become more advanced, and high-performance sensors, such as LiDAR (Light Detection and Ranging), which detects the surrounding environment using laser beams, RADAR (Radio Detection and Ranging), which uses radio waves, ultrasonic sensors, fisheye cameras capable of 360-degree video capture, multifocal lenses, and GPS (Global Positioning System) are being increasingly adopted in vehicles.

Also, it has become possible to implement a so-called super sensor vehicle by aggregating measurement results obtained from multiple sensors. In self-driving or autonomous driving, the concept of a super sensor refers to a technology to more accurately recognize the surrounding environment by combining measurements from various sensors rather than relying on individual sensors for driving convenience or safety. With the addition of Information and Communications Technology (ICT) and cloud technology, sensors and related AI algorithms required for autonomous driving are becoming unprecedentedly sophisticated by remotely accumulating data in fleet of vehicles rather than a single vehicle, and training AI servers and databases to increase the reliability of measurements of vehicle sensors.

Among these, autonomous driving sensors such as radar and LiDAR, which are used to recognize external environments, emit radio waves or laser signals and detect objects present on the road during autonomous driving by measuring the time taken for the radio waves or laser signals to return and the strength of the reflected radio waves or laser signals.

However, object recognition using radar, LiDAR, and AI algorithms is not yet perfect. Despite the advancement of sensor performance and AI technologies, there remains a technical demand for more accurate object recognition. In particular, there is a growing need for confidence evaluations related to object recognition that reflect more realistic driving situations.

### SUMMARY

According to a first aspect of the present disclosure, a system is adapted for recognizing an object using artificial intelligence (AI)-based processing and an autonomous driving sensor. The system recognizes an object present in a surrounding environment based on data input from the autonomous driving sensor, clusters a plurality of points corresponding to the object in the surrounding environment obtained from the autonomous driving sensor, generates tracks for predicted objects, and assigns a confidence score to each of the predicted objects, where the confidence score is differentially assigned to each of the predicted objects based on a Region of Interest (ROI) of a vehicle during autonomous driving.

According to a second aspect of the present disclosure, the confidence score may include an interest track confidence score, which is computed in the ROI based on a first weight applied when the object is in a host lane of the vehicle or a second weight when the object is in a left or right lane adjacent to the host lane of the vehicle.

According to a third of aspect the present disclosure, the interest track confidence score is Interest Track Score Type 1 for an object present in the host lane, and the interest score is track confidence Interest Track Score Type 2 for an object present in the left or right lane, which are given the following equations:

$$Interest Track Score Type1 = maxConfLevel * {w}_{1} \qquad Equation 1$$

$$Interest Track Score Type2 = maxConfLevel * {w}_{2} \qquad Equation 2$$

(where w₁ is the first weight, w₂ is the second weight, and maxConfLevel is a maximum confidence score)

According to a fourth aspect of the present disclosure, the confidence score may be determined by applying a non-interest track confidence score for an object located in a non-region of interest outside the ROI.

According to a fifth aspect of the present disclosure, the non-ROI may be determined based on a first non-interest condition defined as a region outside a road boundary.

According to a sixth aspect of the present disclosure, the non-ROI may be determined based on a second non-interest condition defined as a region located farther in a longitudinal direction than a preceding vehicle that exists in the host lane or the left or right lane of the host lane.

According to a seventh aspect of the present disclosure, even though an object is located closer than the preceding vehicle in the longitudinal direction, when the object is stationary or unidentified, the object may be determined to satisfy a third non-interest condition defined as an object belonging to the non-ROI.

According to an eighth aspect of the present disclosure, the non-interest track confidence score may be applied by limiting the confidence score for the object present in the non-ROI to be less than an upper bound.

According to ninth aspect 3 of the present disclosure, a band-pass filter may be applied to an object having a confidence score less than or equal to an uncontrollable level.

According to a tenth aspect of the present disclosure, for an object with a confidence score greater than the uncontrollable level, the confidence score assigned to the object is ultimately accepted as the differentially-assigned confidence score.

According to an eleventh aspect of the present disclosure, a method for performing artificial intelligence (AI)-based object recognition using an autonomous driving sensor includes clustering a plurality of points corresponding to an object in the surrounding environment obtained from the autonomous driving sensor, generating tracks for predicted objects, and assigning a confidence score to each of the predicted objects, where the confidence score is differentially assigned to each of the predicted objects based on a Region of Interest (ROI) of a vehicle during autonomous driving.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example of an overall system for automatically recognizing an object and controlling a vehicle for purposes of autonomous driving, according to an implementation of the present disclosure;

FIG. 2 is a flowchart illustrating an example of an algorithm for recognizing objects and evaluating confidence by an AI module and an autonomous driving sensor according to an implementation of the present disclosure;

FIG. 3 is a diagram for describing an example of components of a newly defined confidence score according to an implementation of the present disclosure;

FIGS. 4A and 4B are diagrams depicting example driving scenes to describe a method of calculating differential confidence scores for regions of interest (ROI) and non-ROI according to an implementation of the present disclosure;

FIG. 5 is a diagram for describing an example of the results of an actual experiment in which an object recognition and confidence evaluation technique according to an implementation of the present disclosure is applied; and

FIG. 6 is a block diagram illustrating an example of a computing system for autonomous vehicle control and object recognition operation according to an implementation of the present disclosure.

### DETAILED DESCRIPTION

Implementations of the present disclosure provide a system and a method for recognizing objects using Artificial Intelligence (AI) and autonomous driving sensors and evaluating confidence scores (or confidence levels). A system and a method for recognizing an object and evaluating a confidence score for the object, according to examples described herein, can provide enhanced robustness and reliability in object recognition for autonomous driving by evaluating the confidence score differentially, depending on whether the object satisfies one or more criteria that inform whether the object is in a Region of Interest (ROI) and/or a Region of Non-Interest (non-ROI).

Implementations disclosed herein can provide various technical effects. For example, there can be a technical effect of rapidly increasing the reliability score of a track that has entered the region of interest (ROI) to raise its control priority. Additionally, the first and second weights can be adaptively implemented, which are applied to define the maximum reliability score based on the importance of the object in autonomous driving.

Furthermore, in some implementations, for tracks located in a non-interest region, even if the reliability score calculated using autonomous driving sensor information exceeds a control threshold (e.g., over 40), the system can Limit the maximum reliability score to a certain level (e.g., 40), thereby forcibly excluding such tracks from being considered as control targets. For example, by lowering the priority of objects that are relatively distant or located outside the region of interest, such as those outside road boundaries, the system can effectively reduce the influence of control decisions on tracks that do not belong to the region of interest.

Further, effects and advantages of the present disclosure will be apparent to those skilled in the art from the following detailed description and accompanying drawings.

Hereinafter, some implementations of the present disclosure will be described in detail with reference to the exemplary drawings. In adding the reference numerals to the components of each drawing, it should be noted that the identical or equivalent component is designated by the identical numeral even when they are displayed on other drawings. Further, in describing the implementation of the present disclosure, a detailed description of well-known features or functions will be ruled out in order not to unnecessarily obscure the gist of the present disclosure.

In describing the components of the implementation according to the present disclosure, terms such as first, second, “A”, “B”, (a), (b), and the like may be used. These terms are merely intended to distinguish one component from another component, and the terms do not Limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, in the present disclosure, the term “object” has essentially the same meaning as “entity” and the terms “object” and “entity” will be used interchangeably throughout the description of the disclosure.

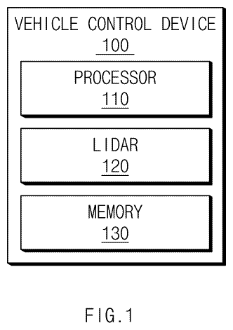

FIG. 1 is a block diagram illustrating an overall system for automatically recognizing an object and controlling a vehicle for purposes of autonomous driving, according to an implementation of the present disclosure.

Referring to FIG. 1, a vehicle control device 100 according to an implementation of the present disclosure may be implemented inside or outside a vehicle, and part of components included in the vehicle control device 100 may be implemented inside or outside the vehicle. In some implementations, the vehicle control device 100 may be integrally formed with internal control units of the vehicle, or may be implemented as a separate device and connected to the control units of the vehicle by separate connection technique. For example, the vehicle control device 100 may further include components not shown in FIG. 1.

The vehicle control device 100, according to an implementation, may include a processor 110, a sensor 120 such as LiDAR or other type of sensor, and a memory 130. The processor 110, the sensor 120, or the memory 130 may be electronically and/or operably coupled with each other by an electronical component including a communication bus.

Hereinafter, hardware being operatively combined may mean that a direct connection or an indirect connection between the hardware is established in a wired or wireless manner, such that second hardware is controlled by first hardware among the hardware.

The implementations shown in the different blocks of FIG. 1 are not intended to be limiting. For example, a part of the pieces of hardware of FIG. 1 may be included in a single integrated circuit, including a system on a chip (SoC). The types and/or number of pieces of hardware included within vehicle control device 100 are not limited to those shown in FIG. 1. For example, the vehicle control device 100 may include only a part of the hardware shown in FIG. 1.

The vehicle control device 100 according to an implementation may include hardware for processing data based on one or more instructions. For example, the hardware for processing the data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may have the structure of a single-core processor, or the structure of a multi-core processor including dual core, quad core, hexa core, or octa core.

According to an implementation, the processor 110 may include at least one of a GPU (graphic processing unit), or an NPU (neural processing unit), or any combination thereof. For example, the GPU may be referred to as a visual processing unit (VPU). For example, the NPU may be referred to as a neural network processing unit.

According to an implementation, the vehicle control device 100 may include a sensor 120, such as a depth sensor, for detecting an external object. For example, the sensor 120 for detecting an external object may include at least one of a time-of-flight (ToF) sensor, LiDAR (Light Detection and Ranging), a structured light sensor, an ultrasonic sensor, an infrared sensor, a RADAR (Radio Detection and Ranging), or an optical distance sensor, or any combination thereof. Hereinafter, for the sake of convenience in description, the description will focus on the sensor 120 implemented as LiDAR, but implementations are not Limited thereto, and the sensor 120 may be implemented as other types of sensors.

According to an implementation, the vehicle control device 100 may include the LiDAR sensor 120 (or simply referred to as LiDAR 120) that acquires a plurality of points based on a pulse laser signal. For example, the LiDAR 120 can acquire sets of data identifying a surrounding object of the vehicle control device 100 (or a vehicle including the vehicle control device 100). For example, the LiDAR 120 may identify a position, a movement direction, or a speed of the surrounding object, or any combination thereof based on the pulse laser signal emitted from the LiDAR 120 being reflected and returned to the surrounding object.

For example, the LiDAR 120 may acquire data sets representing an external object in a space formed by x-axis, y-axis, and z-axis based on the pulse laser signal reflected from the surrounding object. For example, the LiDAR 120 may acquire data sets that include a plurality of points in the space formed by the x-axis, y-axis, and z-axis based on receiving a pulse laser signal at specified intervals. For example, the plurality of points may include points representing an external object within a three-dimensional virtual coordinate system. The three-dimensional virtual coordinate system may include at least one of a vehicle coordinate system or a LiDAR coordinate system, or any combination thereof. However, examples of three-dimensional virtual coordinate systems are not Limited to the above-described coordinate systems.

According to an implementation, the memory 130 of the vehicle control device 100 may include hardware components for storing data and/or instructions that are input to and/or output from the processor 110 of the vehicle control device 100. For example, the memory 130 may include a volatile memory including a random-access memory (RAM), or a non-volatile memory including a read-only memory (ROM).

For example, the volatile memory may include at least one of a dynamic RAM (DRAM), a static RAM (SRAM), a cache RAM or a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disc, a solid state drive (SSD) or an embedded multi-media card (eMMC), or any combination thereof.

For example, the memory 130 of the vehicle control device 100 may store one or more instructions (or commands) indicating arithmetic operations and/or operations to be performed on data by the processor 110 of the vehicle control device 100. A set of one or more instructions may be referred to as a program, firmware, an operating system, a process, a routine, a sub-routine, and/or an application.

In the following, an application being installed in the vehicle control device 100 may mean that one or more instructions provided in the form of an application are stored in the memory 130, wherein the one or more applications are stored in an executable format (e.g., a file with an extension specified by the operating system of the vehicle control device 100) by the processor 110 of the vehicle control device 100.

For example, the memory 130 may include a first neural network model for detecting an object. For example, the memory 130 may include a second neural network model for outputting types of the plurality of points acquired by the LIDAR 120, and/or a score of the plurality of points.

In an implementation, the processor 110 may obtain at least one of a first virtual box for representing a target object, or a first class for representing a type of the target object, or any combination thereof, based on the plurality of points obtained by the LiDAR 120 and the first neural network model stored in the memory 130.

For example, based on inputting the plurality of points into the first neural network model, the processor 110 may obtain at least one of the first virtual box for representing the target object or the first class representing the type of the target object, or any combination thereof. For example, the first neural network model may include an object detection model. For example, the target object may include an external object located within a specified distance from the vehicle control device 100 (or a host vehicle including the vehicle control device 100). For example, the target object may include an object that is identified by the vehicle control device 100 and is tracked, e.g., continuously tracked. For example, the type of the target object may include one or more of a plurality of types for categorizing the target object. For example, the type of the target object may include at least one of a first type representing the ground or a second type representing a type different from the ground, or any combination thereof. However, the type of the target object is not limited to the above-described types. For example, the type of the target object may include, but is not limited to, at least one of a third type representing a person or a fourth type representing a vehicle, or any combination thereof.

In an implementation, the processor 110 may obtain, based on the plurality of points and a second neural network model, at least one of a first subset of points (also referred to herein as first sub-points or first part points) corresponding to at least a part of the target object among the plurality of points or a second class identified through the first subset of points and representing the type of the target object, or any combination thereof. For example, the second neural network model may include a segmentation model.

For example, the second neural network model may include a neural network model for obtaining the type of the plurality of points and a score of the plurality of points.

For example, the processor 110 may obtain the first part points corresponding to at least a part of the target object among the plurality of points, based on inputting the plurality of points into the second neural network model. For example, the processor 110 may identify the type of the plurality of points based on inputting the plurality of points into the second neural network model. For example, based on the type of each of the plurality of points, the processor 110 may obtain first part points that correspond to at least a part of the target object from the plurality of points.

In an implementation, the processor 110 may perform a first specified algorithm on the plurality of points. For example, the processor 110 may perform the first specified algorithm on the plurality of points to classify a type of each of the plurality of points. For example, the processor 110 may classify second sub-points corresponding to a specified type among the plurality of points. For example, the specified type may include a type that represents the ground.

For example, the processor 110 may categorize the second part points corresponding to the specified type based on performing the first specified algorithm on the plurality of points, and obtain (or identify) the first part points by excluding the second part points among the plurality of points.

In an implementation, the processor 110 may obtain at least one of a subclass to obtain a second class, or a score for each of the plurality of points, or any combination thereof, based on inputting the plurality of points into the second neural network model. For example, the processor 110 may obtain the subclass, and the score for each of the plurality of points, based on inputting the plurality of points into the second neural network model. For example, the subclass may include categorizing each of the plurality of points into a certain type.

For example, the processor 110 may fuse the subclass, the score of each of the plurality of points, and the second part points. For example, the processor 110 may perform clustering based on a fusion of the subclass, the score of each of the plurality of points, and the second part points. For example, the clustering may include grouping the first part points corresponding to at least a part of the target object.

For example, the processor 110 may obtain a point cloud for generating a second virtual box based on the first partial points. For example, the processor 110 may obtain a point cloud based on grouping the first sub-points.

For example, the processor 110 may, based on the point cloud, generate a second virtual box for representing the target object that is different from the first virtual box. For example, the second virtual box may include a box that includes at least a part of the first sub-points.

For example, the processor 110 may identify, based on at least one of the first sub-points or the point cloud, or any combination thereof, a heading direction indicative of a direction of travel of the target object.

For example, the processor 110 may identify, based on at least one of the first sub-points or the point cloud, or any combination thereof, a position of the second virtual box in a virtual coordinate system. For example, the processor 110 may identify a size of the second virtual box based on at least one of the first sub-points or the point cloud, or any combination thereof. For example, the processor 110 may identify a second class, based on at least one of the first sub-points or the point cloud, or any combination thereof. For example, the processor 110 may identify at least one of a heading direction indicative of a direction of travel of a target object, a position of a second virtual box in a virtual coordinate system, a size of the second virtual box, or a second class, or any combination thereof, based on at least one of first sub-points, or a point cloud, or any combination thereof. For example, the processor 110 may identify the heading direction of a bounding box based on at least one of the first virtual box, the first class, the heading direction of the second virtual box, the position of the second virtual box, the size of the second virtual box, or the second class, or any combination thereof. For example, the processor 110 may identify the position of a bounding box in the virtual coordinate system based on at least one of the first virtual box, the first class, the heading direction of the second virtual box, the position of the second virtual box, the size of the second virtual box, or the second class, or any combination thereof. For example, the processor 110 may obtain a third class representing a type of the target object corresponding to a bounding box, based on at least one of the first virtual box, the first class, the heading direction of the second virtual box, the position of the second virtual box, the size of the second virtual box, or the second class, or any combination thereof. For example, the processor 110 may obtain at least one of the heading direction of the bounding box, the position of the bounding box in the virtual coordinate system, or the third class representing the type of the target object corresponding to the bounding box, or any combination thereof, based on at least one of the first virtual box, the first class, the heading direction of the second virtual box, the position of the second virtual box, the size of the second virtual box, or the second class, or any combination thereof.

For example, the processor 110 may assign, to the second virtual box, a first identifier for tracking the second virtual box. For example, the processor 110 may assign, to the bounding box, a second identifier corresponding to the first identifier.

For example, the processor 110 may track the bounding box using the second identifier. For example, the processor 110 may track the target object based on identifying a plurality of bounding boxes including the bounding box assigned with the second identifier, among a plurality of frames. For example, in scenarios where the second identifier is an identifier assigned to a bounding box corresponding to the target object, the processor 110 can track the target object by identifying, in a plurality of frames, a plurality of bounding boxes to which the second identifier is assigned.

In an implementation, the processor 110 can output a bounding box corresponding to the target object based on at least one of the first virtual box, the first class, the first sub-points, or the second class, or any combination thereof. For example, the bounding box may include an example where the target object is represented as a cuboid in a virtual coordinate system.

Operations performed by a CPU, GPU, and/or NPU included in the processor 110 are briefly described below.

In an implementation, the processor 110 may include at least one of a CPU, a GPU, or an NPU, or any combination thereof. For example, at least one of the GPU or the NPU, or any combination thereof may obtain a first virtual box and a first class based on a first neural network model. For example, at least one of the GPU or the NPU may obtain the first virtual box and the first class. For example, at least one of the GPU or the NPU, or any combination thereof may obtain a sub-class for acquiring a second class and the score of each of the plurality of points based on a second neural network model. For example, at least one of the GPU or the NPU may obtain a sub-class for acquiring a second class and the score of each of the plurality of points based on a second neural network model. For example, the CPU may categorize second sub-points corresponding to a specified type among the plurality of points based on performing the first specified algorithm for classifying a type of each of the plurality of points.

As described above, the vehicle control device 100 according to an implementation may include at least one processor 110. The vehicle control device 100 may accurately detect the target object by detecting the target object using at least one processor 110. Additionally, in some implementations, the vehicle control device 100 may reduce the Load on each processor by performing parallel processes.

One important point to add in relation to FIG. 1 is that the autonomous driving sensor 120 applied to the vehicle control device 100 according to an implementation of the present disclosure is not limited to a LiDAR, but may also use other types of sensors such as RADAR. As mentioned earlier, with the introduction of object recognition technologies that fuse various autonomous driving sensors, it is unnecessary to restrict the autonomous driving sensor 120 to a single type, such as LiDAR. Accordingly, the autonomous driving sensor 120 may be referred to interchangeably as either LiDAR 120 or RADAR 120, depending on the need. In fact, whether the autonomous driving sensor 120 is a LiDAR or a RADAR, the autonomous driving sensor 120 is merely one of many sensors that may be used for autonomous driving.

Object recognition is described next, including examples based on specific scenarios. Specifically, a description related to examples of object recognition based on autonomous driving sensors is provided below to enhance understanding of the AI-based object recognition of the present disclosure.

In some implementations, the object recognition process using the autonomous driving sensor 120 and AI module may include three stages: pre-processing, segmentation, and tracking.

Pre-processing can be performed by the object recognition system 1000, for example prior to executing an object recognition function. The pre-processing may include operations such as removing ground-forming points based on sensing data (that is, raw data), such as laser or radio waves, or other types, input from the autonomous driving sensor 120. Because laser or radio waves reflected from the ground may cause misrecognition, making it seem as if there are objects on the ground, the process of distinguishing between ground and non-ground may be performed during the preprocessing stage and, in some scenarios, during the segmentation stage.

In some implementations, preprocessing in AI-based object recognition can include a process in which the image processing tool of the AI module within the processor 110 removes noise from the point cloud image and improves computational efficiency by reducing the total number of points in the point cloud image, for example, through techniques such as voxel downsampling.

For reference, in some scenarios, point cloud images may also be represented in a BEV (Bird's Eye View) format. When an autonomous driving sensor map is generated from a top-down perspective-similar to what a bird might see while flying over an urban area-it is referred to as a BEV (Bird's Eye View) image.

In some implementations, as described above, the autonomous driving sensor 120 may emit laser or radio waves into the surrounding environment, generate points for each signal by recording the time it takes for those waves to reflect off external objects and return, and calculate the distances to each of those points. By repeatedly emitting a large number of laser or radio waves, the processor 110 may generate a real-time map of the surrounding environment in a 3D BEV format and, in some scenarios, in a 2D format as well.

The black-and-white lines or surfaces shown on the point cloud map can consist of numerous points, each of which is generated by the sensor (e.g., LiDAR/radar) 120. For this reason, autonomous driving sensing images can also be referred to as point cloud images. In some implementations, when combining RGB-D (Red, Green, Blue-Depth) sensors with LiDAR sensors, the LiDAR point cloud image can be reconstructed in color.

While individual points in the point cloud image may not be recognizable to the human eye, a comprehensive view of the point cloud-such as in BEV format or 2D plane-provides a general understanding of what the surrounding environment looks like for the vehicle currently in autonomous operation. Furthermore, it is also possible to recognize objects such as cars, buses, pedestrians, street trees, and traffic signs within a point cloud image. In AI-based image recognition, these physical items or people are referred to as “objects,” and each object may be classified into a specific group called a “class,” such as the car class or bus class, depending on its characteristics.

Distinguishing which class an object belongs to, such as whether a particular object in the point cloud image is a car or a bus, can be performed with machine-learning techniques, such as a deep neural network. To determine objects within the image of the point cloud and identify their classes using an AI neural network, AI training can be performed beforehand.

Such AI training can utilize datasets of images. For example, the PANDASET™ dataset (source: https;//pandaset.org/#data-collection) includes over 48,000 camera images (primarily of the Silicon Valley area in the United States) and over 16,000 LiDAR scan images. These images are annotated with a total of 28 classes, including pedestrians, cars, bicycles, construction site signs, traffic signs, and the like.

Further, the LiDAR point cloud image may be visualized according to user preferences using point cloud tools like Open3D™ (source: https://www.open3d.org/). Because the LiDAR 120 is able to measure distances, Open3D™ may render 3D LiDAR images more vividly by, for example, displaying distant objects in dark blue and closer objects in light blue.

In addition, as discussed above, in some implementations, the raw image (that is, raw data) can be pre-processed by applying, to the point cloud image, a technique known as voxel downsampling. Here, a voxel refers to a cube-shaped 3D unit element, analogous to a 2D pixel. Voxel downsampling can achieve a reduction in the number of points in a point cloud while preserving the structural integrity of various objects within the point cloud to minimize the computational load required for AI processing.

In some implementations, during a single scan cycle, the autonomous driving sensor 120 emits, for example, “m” laser or radio waves “n” times. In this case, the scan values of the laser/radio waves that reflect off of external objects can be represented as an (m×n) matrix, which is referred to as a range image. Each point that constitutes the point cloud image can include, for example, depth (i.e., range) information, along with additional information such as the intensity, azimuth, and inclination of the reflected laser pulse, and other supplementary data. In some scenarios, the range images may be used for AI training with large-scale datasets such as the WOD (Waymo™ Open Dataset).

Range View (RV) is a technique that can represent a 3D point cloud, for example in a sensor-based 3D map for autonomous driving, such that it is visualized more intuitively by humans. Range view can convert the 3D point cloud into a 2D, for example, 2.5D scene, similar to an analogue-style image, instead of numerous discrete points. In a range view image, the three-dimensional point cloud image has two-dimensional coordinates, but the three-dimensional laser-related information (angle, inclination, intensity, etc.) that was recorded when obtaining the range image earlier may not be discarded. By applying a variable called width to the (x, y) coordinates of (x, y, z) coordinates of a 3D image, one axis of the 2D coordinates is obtained and by applying range image information representing a range (depth) and a variable called height to the z-coordinate, the other axis of the 2D coordinates is obtained, resulting in the construction of the 2D range-view image.

In some implementations, the AI algorithm can utilize a CNN (Convolutional Neural Network), for example as part of an AI training module for extracting features (or keypoints) from image data. The training can utilize datasets containing tens of thousands of images, and the CNNs can be capable of processing 1D to 3D images. The output of the range view image processing tool can be used to train the CNN, which helps the AI accurately recognize objects in the image.

In scenarios where machine-learning is utilized to recognize objects around an autonomous vehicle, the creation of Ground Truth (GT) bounding boxes in the autonomous driving sensor map can also be utilized as part of the object recognition process. In machine learning, “ground truth” refers to the original or actual value of data used for AI training. For example, the GT may be represented as a type of image annotation that is annotated on a point cloud image, for example as a bounding box with box-like boundaries.

To recognize an object, the AI module can utilize labels and group various objects. In some implementations, the spacing of 3D data points used to generate ground truth bounding boxes can also be configured. For example, the spacing can be configured such that each ground truth bounding box contains approximately 50 to 1000 cloud points.

In some scenarios, the raw data captured by sensors such as the radar 120 (LiDAR) while the vehicle is driving may not contain GT annotations. As such, the processor 110 can recognize various objects or entities as belonging to different classes, such as road signs, crosswalks, pedestrians, other vehicles, centerlines, etc. Ground truth (GT) annotations can be used to evaluate object recognition errors by comparing determination results of object recognized by the AI algorithm of the processor 110 with actual data, and sometimes to evaluate AI performance. GT bounding boxes, which can be annotated on the original image in the form of annotations, can be set manually by the user, or can be set through GT computation tools, such as Grid-striding.

Predicted bounding boxes, in addition to GT bounding boxes, can also be utilized in AI object recognition. A predicted bounding box can represent a result of what the processor 110 recognizes as an object of a specified class from original image data obtained from the sensor 120 or the like. Unlike GT Bounding Boxes, predicted bounding boxes can be the result of the autonomous driving AI's computation. The predicted bounding boxes may match GT bounding boxes, or may not match GT bounding boxes or may not have any overlapping regions with the GT bounding boxes at all.

It is noted that predicted bounding boxes are often referred to as Probability Boxes (P-Boxes) or Predicted Bounding Boxes (PBCs), in scenarios where because the predicted bounding boxes do not specify with definitive certainty that an object of a specified class is actually present at a certain location.

Segmentation can be performed, e.g., after preprocessing. Segmentation can involve, for example, marking different parts of the surroundings with different annotations, for example, marking a specific part of the road (e.g., a traffic light) in red, while marking the rest (such as the asphalt road) in blue. Clustering point clouds into certain groups and generating P-Boxes can be also performed in the segmentation stage. In some implementations, a technique called Cluster Expansion can also be used, in which a cluster is expanded to include additional points within an additional Epsilon distance from a minimum distance of the Seed Point (where the minimum distance defines the unexpanded cluster).

In some implementations, the segmentation process can involve clustering and P-Box generation based on the point cloud. For example, the AI network that performs the segmentation can be used to obtain point labels from the autonomous driving sensor 120.

Implementations of the present disclosure can utilize a “Rule-based” road surface recognition and label fusion technique. Such techniques can help address the problem of road surface recognition error during segmentation. In the road surface recognition algorithm, any of various techniques may be applied, which can include slope-based road surface recognition, grid-based road surface recognition, and other non-planar-based road surface recognition.

For reference, semantic segmentation can involve assigning a unique class label to each point in the point cloud generated by the autonomous sensor 120. In point cloud image processing technology, semantic segmentation can extract and utilize meaningful information from data obtained by the autonomous driving sensor for object recognition or scene reconstruction to implement autonomous driving. Various AI models for semantic segmentation can be used, such as projection-based methods, point-based methods, and sparse convolution-based methods. For example, results of the semantic segmentation may be the outcome of AI computation performed by the processor 110 using the NVIDIA DRIVE™ AGX system. Through such a configuration, various colors may be added to the point cloud image.

Post-processing can be performed after the segmentation process. The post-processing can involve converting point cloud data into a three-dimensional map or model that can be meaningful for autonomous driving. The post-processing can also include a process of additionally removing noise or errors in the point cloud image, recognizing objects such as vehicles or pedestrians from the point cloud, and, in some scenarios, assigning unique identifiers to and registering the point cloud data. Assigning a confidence score to each AI-recognized object or P-Box may also be performed in the post-processing stage.

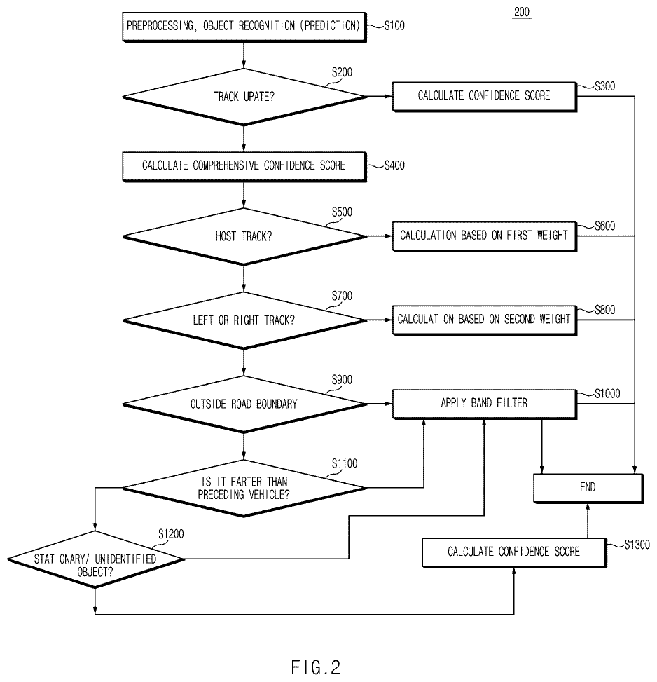

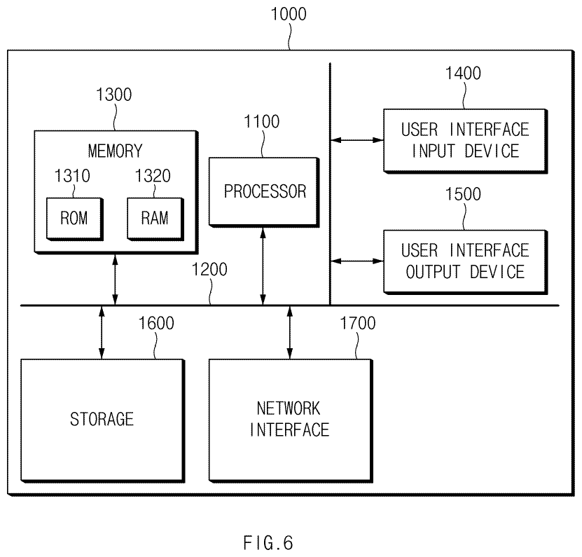

Examples of the core algorithm of implementations of the present disclosure will now be described with reference to FIG. 2. FIG. 2 is a flowchart illustrating an example algorithm 200 for recognizing objects and evaluating confidence by an AI module and an autonomous driving sensor according to an implementation of the present disclosure. The algorithm 200 of FIG. 2 may be implemented and executed, for example, as an AI module on the processor 110 of FIG. 1, and a system 1000 for recognizing objects and evaluating confidence by the AI module and the autonomous driving sensor according to the present disclosure may correspond to the computing system 1000 of FIG. 6, including the algorithm 200 of FIG. 2.

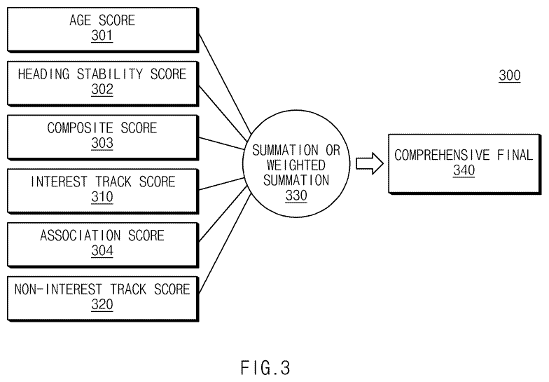

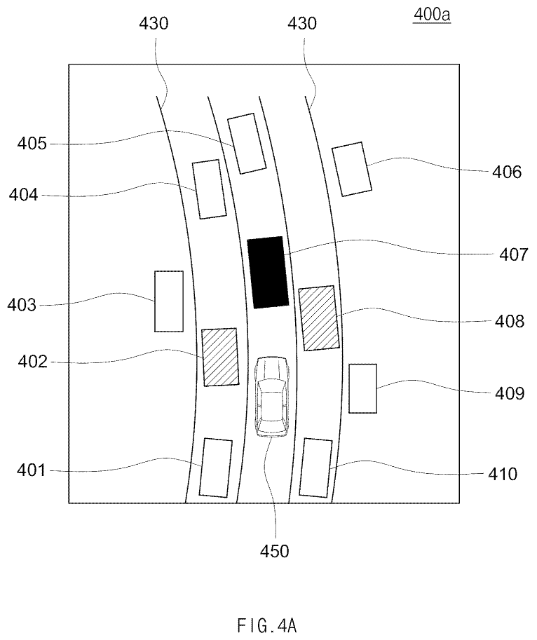

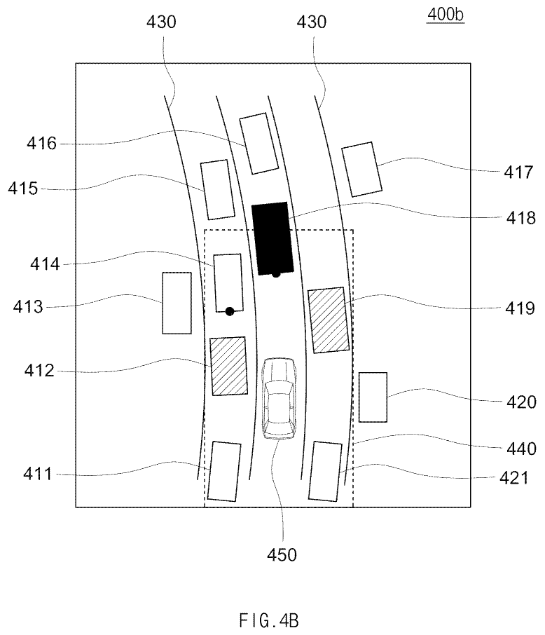

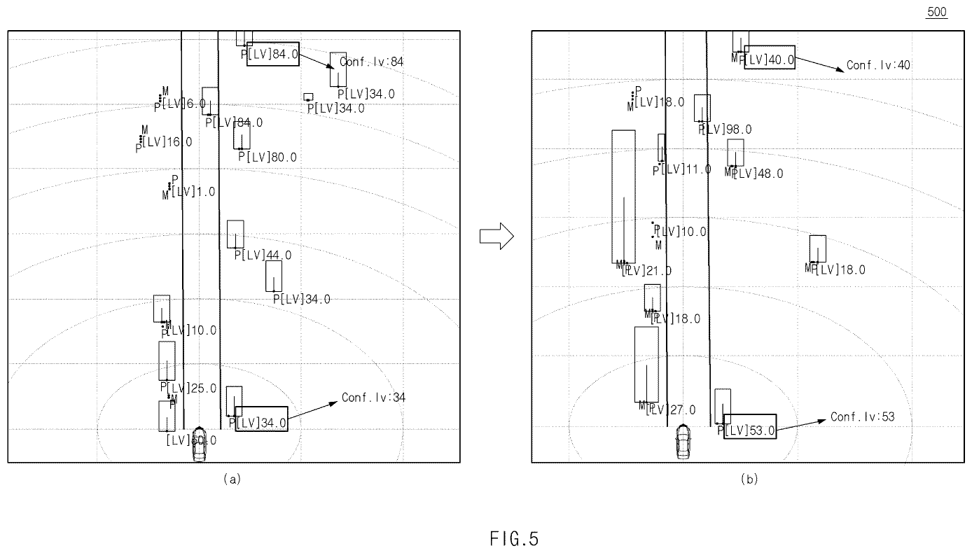

For ease of description and full understanding, in the course of describing FIG. 2, the different operations of FIG. 2 will be described in conjunction with reference to FIGS. 3 through 5. FIG. 3 is a diagram illustrating an example of components of a newly defined confidence score according to an implementation of the present disclosure. FIGS. 4A and 4B are diagrams depicting example driving scenes based on calculating differential confidence scores for regions of interest (ROI) and non-ROI according to an implementation of the present disclosure. FIG. 5 is a diagram illustrating example results of an actual experiment in which an object recognition and confidence evaluation technique according to an implementation of the present disclosure is applied.

In S100 of FIG. 2, the algorithm 200 according to this example of the present disclosure can perform an object tracking operation to recognize an object using the autonomous driving sensor 120 (e.g., radar or the like) previously described in FIG. 1, for example by performing clustering and prediction operations to generate a P-Box, and performing association, prediction, and track updates.

In S200, the algorithm 200 can determine whether the track information, e.g., the driving path such as lane data, related to a host vehicle (e.g., host vehicle 450 in FIGS. 4A and 4B) for autonomous driving has been updated during the object tracking process in S100. When the determination result is NO (track information has not been updated), the algorithm can proceed to S300 to evaluate the confidence of the object and then ends the process. The confidence score can be calculated in S300 without using the specific enhanced techniques provided by implementations of this present disclosure. For example, in calculating the confidence score in step S300, the algorithm can calculate an initial confidence score (e.g., as described with reference to FIG. 3, below), and then update the confidence score by subtracting from the initial confidence score a value obtained by multiplying a certain weight (e.g., 0.1) with a maximum confidence score (e.g., 100).

When the determination result of S200 is YES (track information has been updated), then according to implementations of the present disclosure, the algorithm 200 can calculate a confidence score adaptively and differentially based on different regions detected in the environment of the autonomous vehicle. In the example of FIG. 2, the algorithm can proceed to S400 to calculate an initial comprehensive confidence score. Referring to FIG. 3, the initial overall confidence score calculated in S400 can be derived by summing or weighted-summing a set of basic scores (non-enhanced sores) that do not include additional scoring techniques provided by implementations of the present disclosure. These basic non-enhanced scores can include, for example, the age score 301, the heading stability score 302, the fusion score of various sensors 303, and the association score 304 (the association referring to the process of selecting the most similar cluster (group) for each predicted object and generating a new object using clusters that are not similar to any predicted object). The remaining scoring techniques in FIG. 3, such as the interest track score 310 and the non-interest track score 320, can be determined in a subsequent process described further below.

Next, to refine the initial confidence score determined in S400, the algorithm can determine additional scoring criteria based on whether the track of the object is in a region of interest (e.g., in S500, S700) and/or region of non-interest (e.g., in S900, S1100, S1200). If the object's track is in a region of interest (ROI), then the algorithm can increase the confidence score of the track. If the object's track is in a region of non-interest (non-ROI), then the algorithm can limit the confidence score to a lower value. For example, if the track is in the same track as the host vehicle (in S500) or is in an adjacent track to the host vehicle (in S700), then the track is determined to be in a region of interest (ROI). In S500, for example, a determination is made of whether the object's track is the same as the host vehicle's driving track, based on the initial confidence score calculated in S400.

In this example, when an object has been determined to be in the same lane as the host vehicle (in step S500) and is therefore within the ROI, then in step S600 the algorithm can determine the result as YES and proceed to S600 to execute calculation of the updated confidence score. For example, the updated confidence score in S600 can use a first weight.

Otherwise, when the result of S500 is NO (object is not in the host track), then the algorithm proceeds to S700 to determine whether the object is in an adjacent lane (e.g., left or right lanes) of the track of the host vehicle 450, and is therefore present in the ROI area. If the result is YES in S700, then the algorithm proceeds to step S800 to calculate the updated confidence score. For example, the updated confidence score in S600 can use a second weight according to implementations of the present disclosure.

Examples of S600 and S800 are described next. In S600, if the detected object is in the current lane of the host vehicle 450, then the updated confidence score can use a first type of confidence score of the interest track for the object, defined as Interest Track Score Type1, for example, according to the following equation 1.

$$Interest Track Score Type 1 = maxConfLevel * {w}_{1} \qquad 〈 Equation 1 〉$$

As an example of S800, if the detected object is in an adjacent lane, e.g., a right or left lane of the host vehicle 450, then the updated confidence score can use a second type of confidence score of the interest track for the object, defined as Interest Track Score Type2, for example according to the following equation 2

$$Interest Track Score Type 2 = maxConfLevel * {w}_{2} \qquad 〈 Equation 2 〉$$

Where w₁ is the first weight, w₂ is the second weight, and maxConfLevel is the maximum confidence score.

Based these first type and/or second type of confidence scores, in S600 and S800, for objects that are located within the ROI (e.g., in the host lane or adjacent lanes), the first type of confidence score and/or the second type of confidence score, respectively can be added to the original confidence score (e.g., as obtained in S400) to obtain the updated confidence score. For example, in S600, a value obtained by multiplying the maximum confidence score (e.g., 100) by a first weight (e.g., 0.1) can be added to the original confidence score. And in S800, a value obtained by multiplying the maximum confidence score by a second weight (e.g., 0.05) can be added to the original confidence score. As a result, by adjusting the above-described weights, the recognition of vehicle objects and the priority of autonomous driving control in the subsequent steps can be influenced. This can effectively generate an increased computational importance within the AI processing for “tracks of interest,” e.g., objects satisfying the conditions of either step S500 or step S700, which are determined to be located within the ROI. Such features can provide technical benefits, such as reducing the risk of situations where the target to be controlled is not controlled or is controlled incorrectly.

These technical benefits can provide improvements over systems that, for example, calculate the confidence score of a radar-based generated and tracked object by applying the same criteria for all detection areas. By contrast, implementations of the present disclosure improve on such systems by implementing a differentiated confidence determination algorithm, through S500 to S800, that can increase the confidence score for objects in an ROI.

Referring back to FIG. 2, when a determination of NO is obtained in S700 (object is not in an adjacent track), then the algorithm can determine that the object is not in any region of interest (e.g., the object is not in the host track in S600 and is not in an adjacent track in S700). In such scenarios, the algorithm can further determine whether the object's track is in one or more region(s) of “non-interest” (or non-ROI). If so, then the algorithm can limit the confidence score of tracks within the region(s) of non-interest to a lower value. For example, if the track is outside a road boundary (in S900) or is farther away than preceding vehicles in the host/adjacent lanes (in S1100), then track is determined to be in a region of non-interest. If the object's track is in a region of non-interest, then the track can be referred to as a “non-interest track,” and the algorithm can calculate the updated confidence score of the non-interest track in S1000.

For example, in S900, it can be determined whether the object is located outside the road boundary (e.g., road boundary 430 in FIGS. 4A and 4B). In the examples of FIGS. 4A and 4B, objects outside the road boundary include vehicles 403, 406, 409 in FIG. 4A and vehicles 413, 417, 420 in FIG. 4B, and these objects will receive a determination of YES in S900. In S900, implementations of the present disclosure can designate the area outside the road boundary as a non-region of interest (non-ROI). Based on this, a specific condition, referred to as a “first non-interest condition,” can be defined as whether or not the object falls in a first non-ROI, such as outside the road boundary in S900.

Referring back to FIG. 2, if a determination of NO is obtained in S900 (not outside the road boundary), then the algorithm can proceed to determine whether the object track is in other regions of non-interest, e.g., in S1100 and S1200. For example, the algorithm can proceed to S1100 to determine whether the object is located farther than a threshold distance (e.g., a threshold longitudinal distance) from the preceding vehicle in the host/adjacent lanes. As such, in S1100, a “second non-interest condition” can be defined as whether or not an object falls in a second non-region of interest (second non-ROI), such as whether an object in the host lane or adjacent lane is farther away than the preceding vehicle by the threshold longitudinal distance or more.

If a determination of NO is obtained in S1100, then the algorithm can proceed to S1200 to further determine whether the object is a stationary object or unidentified object. As such, even though a result of NO is determined in both S900 and S1100, the algorithm can define yet a “third non-interest condition” in S1200 as the object being a stationary object (e.g., based on identifying whether the object is moving due to Doppler effect of radar) or the object being an unidentified object (e.g., an object whose classification is unclear). Based on this, the algorithm can determine that a third non-interest condition is satisfied in S1200 if the object falls in this third non-region of interest (third non-ROI).

As discussed above, if a result of YES is determined in any of S900, S1100, or S1200, then the algorithm can determine that the object is within a region of non-interest (i.e., the object's track is a non-interest track). In such scenarios, the algorithm can limit the confidence score of the object's track to a lower value. For example, the algorithm can apply a band filter in S1000, and terminate tracking for the object. For reference, the band filter applied in S1000 can limit the confidence score of an object for which a determination of YES was made in S900, S1100, or S1200. For example, even if the confidence score calculated in S400 is 70, the band filter in S1000 can lower the confidence score to a predetermined upper limit or cap, such as 40. As such, an object that receives a determination of YES in S900, S1100, or S1200 can be filtered out by the band filter because the object would be unqualified to be considered as an object of interest for control, due to the artificially imposed cap.

In some implementations, if a determination of NO is received all in of S900, S1100, and S1200, then the algorithm can proceed to S1300 to determine a final confidence score and terminate the process. For example, the final confidence score can simply be the initial confidence score determined in S400, without modification. This is in contrast to steps S600 and S800 (for an object present in an ROI, e.g., in the host lane or adjacent lane), where the initial confidence score of S400 was increased by summing with a value obtained by multiplying the maximum confidence score (e.g., 100) by the first weight (e.g., 0.1) or the second weight (e.g., 0.05). By contrast, according to some implementations in S1300, there is no such summing process.

FIG. 4A is a diagram illustrating an example of calculating the confidence score of the interest track in S500 to S800 (tracks in regions of interest). In a driving situation 400a illustrated in FIG. 4A, there are a total of 10 vehicles 401, 402, 403, 404, 405, 406, 407, 408, 409, and 410 on the road in addition to the host vehicle 450. As shown in FIG. 4A, the vehicle 407, which is the closest vehicle in the same lane as the host vehicle 450, is selected as a first object of interest to which the first weight is to be applied (e.g., in S500, S600 of FIG. 2), and the closest vehicles to the host vehicle 408 in the left and right lanes (i.e., vehicle 402 and vehicle 408) are selected as a second object of interest to which the second weight is to be applied (e.g., in S700, S800 of FIG. 2).

FIG. 4B is a diagram illustrating an example of calculating the confidence score of a non-interest track according to S900 to S1200 (tracks in regions of non-interest). In the driving situation 400b shown in FIG. 4B, an ROI 440 may be identified and the objects that satisfy the first non-interest condition described above, i.e., objects that exist outside the roadway boundary 430, may be the three vehicles 413, 417, and 420. These objects may be the first non-interest objects. It is noted that all other regions shown in FIG. 4B, except for the ROI 440 box, may be non-regions of interest.

In some implementations, the vehicle 414 may be excluded from consideration as a non-interest object because the vehicle 414 is closer in longitudinal distance than the highest-priority object of interest (vehicle 418 in FIG. 4B) although the vehicle 414 is located at a greater longitudinal distance than the closest vehicle in the adjacent left lane (i.e., vehicle 412) relative to the host vehicle 450. The longitudinal distance in the longitudinal direction may be measured, for example, based on the rear point of the vehicles as shown in FIG. 4B (represented by a dot). In this example, because the vehicle 414 is excluded from the non-interest object, the object can be considered to have a potential for cut-in.

In FIG. 4B, the second-priority objects of interest are two vehicles 412 and 419 (closest vehicles in adjacent lanes to the host vehicle).

Meanwhile, objects located farther in longitudinal distance in the longitudinal direction than any object of interest are categorized as second-priority objects of non-interest. For example, in FIG. 4B, vehicles 415 and 416 correspond to the second-priority objects of non-interest. Although not depicted in FIG. 4B, stationary or unidentified objects may be classified as third-priority objects of non-interest.

As described above, the present disclosure does not apply a uniform criterion across all detection areas, but instead implements a strategy that differentiates the confidence score computation method based on the degree of interest. In this way, objects detected by autonomous driving sensors such as radar may be granted priority in AI processing and control.

In some scenarios, in the post-processing described above, implementations of the present disclosure can delete objects recognized as false by the autonomous driving sensor 120 such as RADAR, and manage the lifecycle and movement attributes, classes, etc. of radar-tracked objects. As discussed with reference to FIGS. 1 and 2, implementations of the present disclosure can estimate the optimal current position/velocity information using a predicted object and its associated cluster.

The example algorithm 200 described in implementations of the present disclosure can determine the confidence score of the generated track differentially according to the degree of interest of the region. In some scenarios, the algorithm 200 can be implemented in a confidence evaluation step, which can be performed after the object tracking process has estimated all the states and positions of the radar track (e.g., in S100 of FIG. 2). Referring to FIG. 5, scenarios (a) and (b)

illustrate examples of confidence scores in an alternative technique and in implementations of the present disclosure, respectively. Scenario (a), shows a host vehicle at the very bottom of (a) and two different tracks annotated with light-colored bounding boxes, one track in the upper portion of (a) and another track in the lower portion of (a). The upper track is further away from the host vehicle than the lower track. Nonetheless, the upper track could be assigned a larger confidence score than the lower track, for example based on aggregating scores 301, 302, 303, and 304 in FIG. 3 that fail to take into consideration the degrees of interest of the two tracks. In the example of (a), the confidence score of the upper track (which is farther in longitudinal distance) is calculated to be significantly higher than that of the lower track (the right-front vehicle track adjacent to the host vehicle, which has a high likelihood of cutting in front of the host vehicle). In this situation, there is a risk that the lower track, despite its apparently high degree of interest to the host vehicle, may not be selected as a control target due to its low confidence score.

In contrast, as shown in scenario (b) of FIG. 5, the confidence score of the right-front vehicle track (the lower track), which has been selected as an interest track, is increased. Conversely, the confidence score of upper track, which is farther away than the interest track and is deemed a non-interest track, is suppressed to a smaller limited value (e.g., 40), which indicates unsuitability for control. In this way, confidence scores can be adaptively determined for each ROI.

The confidence score of an object tracked by the autonomous driving sensor (e.g., sensor 120 which may be radar) can be then used in determining the output priority of different radar tracks during fusion of multiple types of sensors. By assigning a higher priority to target tracks that are deemed important for control during autonomous driving, the method supports more effective selection of control tracks.

As such, by adaptively adjusting the confidence scores of tracked objects based on their degree of interest, the priority of those tracks can also be adaptively adjusted when considering whether to include those tracks as part of the control of autonomous driving. Conversely, implementations of the present disclosure can reduce the influence of control on tracks outside the region of interest by lowering the priority of objects that are either relatively distant or located outside the region of interest (e.g., beyond the road boundaries).

FIG. 6 is a block diagram illustrating an example computing system 1000 for autonomous vehicle control and object recognition operation according to an implementation of the present disclosure.

Referring to FIG. 6, the computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the implementations disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the implementation disclosed in the present disclosure is not intended to limit the technical idea of the present disclosure but to describe the present disclosure, and the scope of the technical idea of the present disclosure is not limited by the implementation. The scope of protection of the present disclosure should be interpreted by the following claims, and all technical ideas within the scope equivalent thereto should be construed as being included in the scope of the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system adapted to perform object recognition using sensor data collected by an autonomous driving sensor, the system comprising:
at least one processor; and
at least one memory storing computer program instructions that, based on being executed by the at least one processor, perform artificial intelligence (AI)-based operations of recognizing objects in surrounding environment based on the sensor data obtained from the autonomous driving sensor, the operations comprising:
detecting point cloud data from the sensor data obtained from the autonomous driving sensor;
performing clustering on the point cloud data to obtain a plurality of clusters each comprising one or more points, wherein the plurality of clusters correspond to a plurality of objects in the surrounding environment;
generating predictions of tracks for the plurality of objects, based on the plurality of clusters;
determining a plurality of regions of interest (ROIs) in the surrounding environment; and
for each object among the plurality of objects:
determining whether the object satisfies at least one of a plurality criteria for the plurality of ROIS; and
based on determining that the object satisfies at least one criteria for an ROI, assigning a confidence score to the object, wherein the confidence score is differentially assigned depending on the ROI for which the at least one criteria is satisfied.

2. The system of claim 1, wherein the plurality of criteria for the plurality of ROIs comprises (a) a first criterion of whether the object is in a same lane as a host vehicle, and (b) a second criterion of whether the object is in an adjacent lane to the host vehicle, and
wherein the confidence score includes an interest track confidence score, which is determined by applying a first weight to the confidence score when the first criterion is satisfied, and applying a second weight to the confidence score when the second criterion is satisfied, wherein the second weight is different from the first weight.

3. The system of claim 2, wherein the interest track confidence score is Interest Track Score Type1 for an object satisfying the first criterion, and wherein the interest track confidence score is Interest Track Score Type2 for an object satisfying the second criterion, wherein Equation 1 and Equation 2 are given by the following:
$$Interest Track Score Type 1 = max ConfLevel * {w}_{1} \qquad Equation 1$$
$$Interest Track Score Type 2 = max ConfLevel * {w}_{2} \qquad Equation 2$$
wherein w₁ is the first weight, w₂ is the second weight, and maxConfLevel is a maximum confidence score.

4. The system of claim 1, wherein the operations further comprise:
determining a region of non-interest (non-ROIs) that is outside the plurality of ROIs; and
for each object among the plurality of objects:
determining whether the object satisfies a criterion for the non-ROI; and
based on determining that the object satisfies the criterion for the non-ROI, assigning the confidence score to the object differentially depending on the non-ROI for which the criterion is satisfied.

5. The system of claim 4, wherein the assigning of the confidence score comprises applying a non-interest track confidence score, which depends on the non-ROI for which the criterion was satisfied.

6. The system of claim 5, wherein the criterion for the non-ROI comprises a first non-interest criterion of whether the object is outside of a road boundary.

7. The system of claim 6, wherein the criterion for the non-ROI comprises a second non-interest criterion of whether the object is located farther away from a host vehicle in a longitudinal direction as compared to a preceding vehicle in a same lane as the host vehicle or in an adjacent lane to the hos vehicle.

8. The system of claim 7, wherein for an object that is located closer than the preceding vehicle in the longitudinal direction, based on determining that the object is stationary or unidentified, the object is determined to satisfy a third non-interest criterion condition for the non-ROI.

9. The system of claim 7, wherein for an object that satisfies the second non-interest criterion,
the object is excluded from satisfying the second non-interest criterion if the object (i) is in the adjacent lane to the host vehicle and (ii) is located closer in the longitudinal direction as compared to the preceding vehicle in the same lane as the host vehicle.

10. The system of claim 5, wherein the applying of the non-interest track confidence score comprises limiting the confidence score of the object satisfying the criterion for the non-ROI to be less than an upper bound.

11. A method for performing artificial intelligence (AI)-based object recognition using an autonomous driving sensor, the method comprising:
detecting point cloud data from sensor data obtained from the autonomous driving sensor;
performing clustering on the point cloud data to obtain a plurality of clusters each comprising one or more points, wherein the plurality of clusters correspond to a plurality of objects in a surrounding environment;
generating predictions of tracks for the plurality of objects, based on the plurality of clusters;
determining a plurality of regions of interest (ROIs) in the surrounding environment; and
for each object among the plurality of objects:
determining whether the object satisfies at least one of a plurality criteria for the plurality of ROIS; and
based on determining that the object satisfies at least one criteria for an ROI, assigning a confidence score to the object, wherein the confidence score is differentially assigned depending on the ROI for which the at least one criteria is satisfied.

12. The method of claim 11, wherein the plurality of criteria for the plurality of ROIs comprises (a) a first criterion of whether the object is in a same lane as a host vehicle, and (b) a second criterion of whether the object is in an adjacent lane to the host vehicle, and
wherein the confidence score includes an interest track confidence score, which is determined by applying a first weight to the confidence score when the first criterion is satisfied, and applying a second weight to the confidence score when the second criterion is satisfied, wherein the second weight is different from the first weight.

13. The method of claim 12, wherein the interest track confidence score is Interest Track Score Type1 for an object satisfying the first criterion, and wherein the interest track confidence score is Interest Track Score Type2 for an object satisfying the second criterion, wherein Equation 1 and Equation 2 are given by the following:
$$Interest Track Score Type 1 = max ConfLevel * {w}_{1} \qquad Equation 1$$
$$Interest Track Score Type 2 = max ConfLevel * {w}_{2} \qquad Equation 2$$
wherein w₁ is the first weight, w₂ is the second weight, and maxConfLevel is a maximum confidence score.

14. The method of claim 11, wherein the method further comprises:
determining a region of non-interest (non-ROIs) that is outside the plurality of ROIs; and
for each object among the plurality of objects:
determining whether the object satisfies a criterion for the non-ROI; and
based on determining that the object satisfies the criterion for the non-ROI, assigning the confidence score to the object differentially depending on the non-ROI for which the criterion is satisfied.

15. The method of claim 14, wherein the assigning of the confidence score comprises applying a non-interest track confidence score, which depends on the non-ROI for which the criterion was satisfied.

16. The method of claim 15, wherein the criterion for the non-ROI comprises a first non-interest criterion of whether the object is outside of a road boundary.

17. The method of claim 16, wherein the criterion for the non-ROI comprises a second non-interest criterion of whether the object is located farther away from a host vehicle in a longitudinal direction as compared to a preceding vehicle in a same lane as the host vehicle or in an adjacent lane to the hos vehicle.

18. The method of claim 17, wherein for an object that is located closer than the preceding vehicle in the longitudinal direction, based on determining that the object is stationary or unidentified, the object is determined to satisfy a third non-interest criterion condition for the non-ROI.

19. The method of claim 17, wherein for an object that satisfies the second non-interest criterion for the non-ROI,
the object is excluded from satisfying the second criterion for the non-ROI if the object (i) is in the adjacent lane to the host vehicle and (ii) is located closer in the longitudinal direction as compared to the preceding vehicle in the same lane as the host vehicle.

20. The method of claim 15, wherein the applying of the non-interest track confidence score comprises limiting the confidence score of the object satisfying the criterion for the non-ROI to be less than an upper bound.
